(19) United States
(12) Patent Application Publication
(10) Pub. No.: US 2023/0284310 A1
(43) Pub. Date: Sep. 7, 2023

(54) METHODS AND APPARATUSES FOR A FAILURE HANDLING PROCEDURE IN A SIDELINK RELAY SYSTEM

(71) Applicant: LENOVO (BEIJING) LIMITED, BEIJING (CN)

(72) Inventors: LIANHAI WU, BEIJING (CN); MINGZENG DAI, SHANGHAI (CN); JING HAN, BEIJING (CN); RAN YUE, BEIJING (CN); HAIMING WANG, BEIJING (CN); MIN XU, BEIJING (CN)

(21) Appl. No.: 18/040,659

(22) PCT Filed: Aug. 6, 2020
(86) PCT No.: PCT/CN2020/107421

§ 371 Date: Feb. 6, 2023

(51) Int. Cl. H04W 76/18; H04W 76/14

(52) U.S. Cl. CPC H04W 76/18; H04W 76/14; H04W 88/04

(57) ABSTRACT

Embodiments of the present application relate to methods and apparatuses for a failure handling procedure in a sidelink relay system under 3rd Generation Partnership Project (3GPP) 5G New Radio (NR). According to an embodiment of the present application, a method can include: establishing a PC5 radio resource control (RRC) connection of a link between a user equipment (UE) and a relay UE, wherein a PC5 RRC connection of a link between the relay UE and another UE has been established; receiving a failure notification from the relay UE, wherein the failure notification indicates an occurrence of a failure on the link between the relay UE and the abovementioned another UE; monitoring a discovery resource pool upon receiving the failure notification from the relay UE, and reporting failure information associated with the relayed connection to a base station (BS).

### TECHNICAL FIELD

Embodiments of the present application generally relate to wireless communication technology, especially to methods and apparatuses for a failure handling procedure in a sidelink relay system.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a user equipment (UE) that is located in the coverage or far from the BS, which can result in relatively low signal quality. A RN may also be named as a relay UE in some cases. A 3GPP 5G sidelink system including a relay UE may be named as a sidelink relay system.

Currently, in a 3GPP 5G New Radio (NR) system or the like, details regarding how to provide a failure handling procedure in a sidelink relay system has not been specifically discussed yet.

### SUMMARY

Some embodiments of the present application provide a method for wireless communications. The method may be performed by a UE. The method includes: establishing a PC5 radio resource control (RRC) connection of a link between the UE and a relay UE, wherein a PC5 RRC connection of a link between the relay UE and another UE has been established; and receiving a failure notification from the relay UE, wherein the failure notification indicates an occurrence of a failure on the link between the relay UE and the abovementioned another UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method for receiving a failure notification performed by a UE.

Some embodiments of the present application provide a further method for wireless communications. The method may be performed by a relay UE. The method includes: detecting whether a failure occurs on a link between the relay UE and another UE, wherein a PC5 RRC connection of a link between a UE and the relay UE has been established, and wherein a PC5 RRC connection of the link between the relay UE and the abovementioned another UE has been established; and in response to detecting that the failure occurs on the link between the relay UE and the abovementioned another UE, transmitting a failure notification to the UE, wherein the failure notification indicates an occurrence of the failure on the link between the relay UE and the abovementioned another UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned further method for transmitting a failure notification performed by a relay UE.

Some embodiments of the present application provide a further method for wireless communications. The method may be performed by a UE. The method includes: transmitting a RRC reconfiguration for relayed sidelink message to a relay UE, wherein a RRC relayed connection of a link between the UE and another UE has been established; starting a timer for controlling a reconfiguration procedure; and in response to an expiry of the timer or in response to receiving a RRC reconfiguration failure for relayed sidelink message from the relay UE, reporting failure information to a BS, wherein the failure information indicates a failure on the RRC relayed connection of the link between the UE and the abovementioned another UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned further method for reporting failure information performed by a UE.

Some embodiments of the present application provide a further method for wireless communications. The method may be performed by a relay UE. The method includes: receiving a RRC reconfiguration for relayed sidelink message from a UE; starting a timer for controlling a reconfiguration procedure; and in response to receiving a RRC reconfiguration failure sidelink message from another UE, transmitting a RRC reconfiguration failure for relayed sidelink message to the UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned further method for transmitting a RRC reconfiguration failure for relayed sidelink message performed by a relay UE.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary flowchart of a sidelink RRC reconfiguration procedure in accordance with some embodiments of the present application;

FIG. 3 illustrates an exemplary flowchart of a sidelink UE information procedure in accordance with some embodiments of the present application;

FIG. 4 illustrates a flow chart of a method for receiving a failure notification in accordance with some embodiments of the present application;

FIG. 5 illustrates a flow chart of a method for transmitting a failure notification in accordance with some embodiments of the present application;

FIG. 6 illustrates a flow chart of a method for reporting failure information in accordance with some embodiments of the present application;

FIG. 7 illustrates a flow chart of a method for transmitting a RRC reconfiguration failure for relayed sidelink message in accordance with some embodiments of the present application; and

FIG. 8 illustrates a simplified block diagram of an apparatus for a failure handling procedure in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

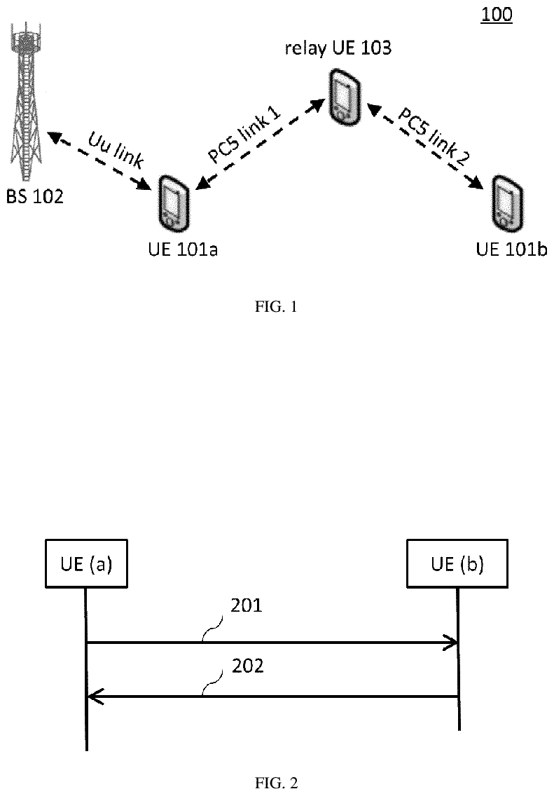

FIG. 1 illustrates a schematic diagram of a wireless communication system in accordance with some embodiments of the present application.

As shown in FIG. 1, the wireless communication system 100 includes two UEs (i.e., UE 101a and UE 101b), a BS 102, and a relay UE 103 for illustrative purpose. Although a specific number of UE(s), relay UE(s), and BS(s) are depicted in FIG. 1, it is contemplated that any number of UE(s), relay UE(s), and BS(s) may be included in the wireless communication system 100.

Due to a far distance between UE 101a and UE 101b, these two UEs communicate with each other via the relay UE 103. UE 101a and UE 101b may be connected to the relay UE 103 via a network interface, for example, a PC5 interface as specified in 3GPP standard documents. UE 101a may be connected to the BS 102 via a network interface, for example, a Uu interface as specified in 3GPP standard documents. Referring to FIG. 1, UE 101a is connected to the relay UE 103 via PC5 link 1, UE 101b is connected to the relay UE 103 via PC5 link 2, and UE 101a is connected to the BS 102 via a Uu link.

In some embodiments of the present application, UE 101a, UE 101b, or the relay UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

In some further embodiments of the present application, UE 101a, UE 101b, or the relay UE 103 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101a, UE 101b, or the relay UE 103 may include wearable devices, such as smart watches, fitness bands, optical head-mounted displays, or the like. Moreover, UE 101a, UE 101b, or the relay UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL), and UE(s) 101 (e.g., UE 101a, UE 101b, or other similar UE) transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a Physical Downlink Control Channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited UE or a power sensitive UE.

FIG. 2 illustrates an exemplary flowchart of a sidelink RRC reconfiguration procedure in accordance with some embodiments of the present application.

As shown in FIG. 2, in step 201, UE (a) (e.g., UE 101a or UE 101b as illustrated and shown in FIG. 1) initiates a sidelink RRC reconfiguration procedure to UE (b) (e.g., UE 101b or UE 101a as illustrated and shown in FIG. 1) by transmitting a RRCReconfigurationSidelink message to UE (b).

If the sidelink RRC reconfiguration procedure is successfully completed, in step 202, UE (b) may transmit “a RRC reconfiguration complete sidelink message” to UE (a), e.g., a RRCReconfigurationCompleteSidelink message as specified in 3GPP standard documents. Alternatively, if the sidelink RRC reconfiguration procedure is not successfully completed, in step 202, UE (b) may transmit “a RRC reconfiguration failure sidelink message” to UE (a), e.g., a RRCReconfigurationFailureSidelink message as specified in 3GPP standard documents.

The purpose of a sidelink RRC reconfiguration procedure is to modify a PC5 RRC connection, e.g., to establish, modify, or release sidelink data radio bearers (DRBs), to configure NR sidelink measurement and reporting, and to configure sidelink channel state information (CSI) reference signal resources.

A UE (e.g., UE (a) as illustrated and shown in FIG. 2) may initiate the sidelink RRC reconfiguration procedure and perform operations on the corresponding PC5 RRC connection in following cases:
a release of sidelink DRBs associated with a peer UE (e.g., UE (b) as illustrated and shown in FIG. 2);
an establishment of sidelink DRBs associated with the peer UE;
modification for the parameters included in Sidelink radio bearer (SLRB)-Config of sidelink DRBs associated with the peer UE;
configuration information of the peer UE to perform NR sidelink measurement and report; and
configuration information of the sidelink CSI reference signal resources.

A UE capable of NR sidelink communication may initiate a procedure of sidelink UE information for NR, to report to a network or a B S that a sidelink radio link failure (RLF) (e.g., timer T400 expiry) or a sidelink RRC reconfiguration failure has been declared.

The following table shows an introduction of timer T400 as specified in 3GPP standard documents, including a starting condition, a stop condition, an operation at expiry, and a possible general name for the timer.

| Timer | Start | Stop | At expiry | Name |
|---|---|---|---|---|
| T400 | upon transmission of | upon reception of | perform the sidelink | a timer for |
| | RRCReconfigurationSidelink | RRCReconfiguration | RRC reconfiguration | transmission of |
| | | FailureSidelink or | failure procedure as | RRC reconfiguration |
| | | RRCReconfiguration | specified in sub-clause | for sidelink |
| | | CompleteSidelink | 5.8.9.1.8 of TS38.331 | |

FIG. 3 illustrates an exemplary flowchart of a sidelink UE information procedure in accordance with some embodiments of the present application.

As shown in FIG. 3, in step 301, a UE (e.g., UE 101a or UE 101b as illustrated and shown in FIG. 1 or UE (a) as illustrated and shown in FIG. 2) transmits “a sidelink UE information NR message” to a BS (e.g., BS 102 as illustrated and shown in FIG. 1), e.g., a SidelinkUEinformationNR message as specified in 3GPP standard documents. Specifically, the sidelinkUEinformationNR message may include sidelink failure information. The sidelink failure information may include a sidelink destination identity (ID) and a sidelink failure cause.

Currently, in a sidelink relay system under 3GPP 5G NR, details regarding how to provide a failure handling procedure has not been specifically discussed yet. Embodiments of the present application provide a failure handling procedure in a sidelink relay system, for example, whether a relay UE reports a failure notification to a UE when a RLF of the link between the relay UE and another UE happens or when the relay UE receives a RRCReconfigurationFailureSidelink message from another UE. More details will be illustrated in the following text in combination with the appended drawings.

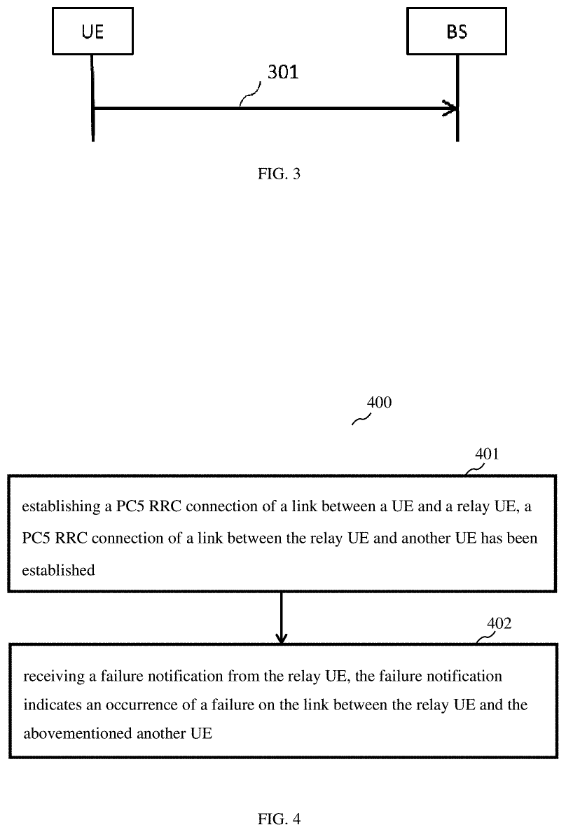

FIG. 4 illustrates a flow chart of a method for receiving a failure notification in accordance with some embodiments of the present application. The method may be performed by a UE (e.g., UE 101a or UE 101b as illustrated and shown in FIG. 1, UE (a) as illustrated and shown in FIG. 2, or the UE as illustrated and shown in FIG. 3). Although described with respect to a UE, it should be understood that other devices may be configured to perform a method similar to that of FIG. 4.

In the exemplary method 400 as shown in FIG. 4, in operation 401, a UE (e.g., UE 101a illustrated and shown in FIG. 1) establishes a PC5 RRC connection of a link between the UE and a relay UE (e.g., the relay UE 103 illustrated and shown in FIG. 1). The embodiments of FIG. 4 assume that a PC5 RRC connection of a link between the relay UE and another UE (e.g., UE 101b illustrated and shown in FIG. 1) has been established.

In an example, the UE further establishes a RRC relayed connection of a link between the UE and the abovementioned another UE. The RRC relayed connection of the link is a logical link and may also be named as “an end-to-end link” between the UE and the abovementioned another UE.

In operation 402, the UE receives a failure notification from the relay UE. The failure notification indicates an occurrence of a failure on the link between the relay UE and the abovementioned another UE. The failure notification may be included in: a RRC signaling, a control packet data unit (PDU) in a sidelink adaptation protocol (SLAP) layer, and a MAC control element (CE).

In an embodiment, the failure notification includes the abovementioned another UE's ID, which may also be named as a destination ID. For instance, with reference to FIG. 1, the failure notification includes:
a destination ID associated with an end-to-end link between UE 101a and UE 101b, if the end-to-end link is established; or
a destination ID associated with the link between relay UE 103 and UE 101b.

In a further embodiment, the failure notification includes a failure cause. The failure cause may be “a sidelink radio link failure (RLF)” or “a configuration failure”. For instance, a RLF is included in the failure notification for the sidelink RLF, and a configuration failure is included in the failure notification for a sidelink RRC reconfiguration failure. The failure notification may further include at least one failure cause of:
reaching a maximum number of retransmissions of a RLC entity of the relay UE;
an expiry of a timer for transmission of RRC reconfiguration for sidelink (e.g., timer T400);
reaching a maximum number of consecutive hybrid automatic repeat request (HARM) discontinuous transmission (DTX); and
an integrity check failure.

According to some embodiments, the UE further declares a sidelink RLF of the link between the UE and the relay UE. If a RRC relayed connection of a link between the UE and the abovementioned another UE is established, the UE may further declare a sidelink RLF of the link between the UE and the abovementioned another UE.

According to some embodiments, the UE further releases DRBs and signaling radio bearers (SRBs) of the link between the UE and the relay UE, and discards sidelink communication configuration information of the link between the UE and the relay UE. If a RRC relayed connection of a link between the UE and the abovementioned another UE is established, the UE may further release DRBs and SRBs of the link between the UE and the abovementioned another UE, and the UE may further discard sidelink communication configuration information of the link between the UE and the abovementioned another UE.

According to some embodiments, the UE further:
resets sidelink specific medium access control (MAC) configuration information of the link between the UE and the relay UE;
sets a connection status of the link between the UE and the relay UE to a release status; and
indicates “the release status of the link between the UE and the relay UE” to an upper layer of the abovementioned another UE.

If a RRC relayed connection of a link between the UE and the abovementioned another UE is established, the UE may further:
reset sidelink specific MAC configuration information of the link between the UE and the abovementioned another UE;
set a connection status of the link between the UE and the abovementioned another UE to a release status; and
indicate the release status of the link between the UE and the abovementioned another UE to the upper layer of the abovementioned another UE.

According to some embodiments, the UE further determines whether the UE is in coverage of a BS (e.g., the BS 102 illustrated and shown in FIG. 1). If the UE determines that the UE is in the coverage of the BS, the UE may report failure information to the BS upon receiving the failure notification. The failure information is associated with the received failure notification.

For instance, the failure information may include: a status of the link between the UE and the relay UE; and a status of the link between the relay UE and the abovementioned another UE. The status of the link between the UE and the relay UE may represent “an occurrence of a RLF” or “a link being available”. Similarly, the status of the link between the relay UE and the abovementioned another UE may represent “an occurrence of a RLF” or “a link being available”.

According to some embodiments, the UE further receives a RRC reconfiguration message from a BS and performs a relay reselection procedure. The RRC reconfiguration message instructs the UE to perform the relay reselection procedure. According to some other embodiments, the UE performs a relay reselection procedure upon receiving the failure notification.

During performing the relay reselection procedure, the UE monitors a discovery resource pool to find one or more relay UEs, and selects one relay UE within the found one or more relay UEs. The UE may further establish a PC5 RRC connection of a link between the UE and the selected relay UE.

Details described in all other embodiments of the present application (for example, details of how to handle a failure on a link between a relay UE and a UE) are applicable for the embodiments of FIG. 4. Moreover, details described in the embodiments of FIG. 4 are applicable for all the embodiments of FIGS. 1-3 and 5-8.

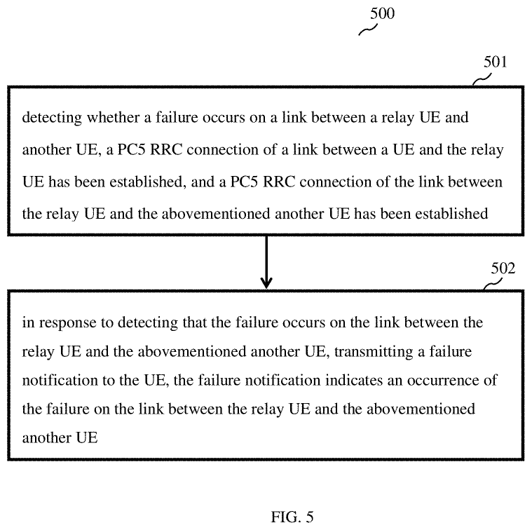

FIG. 5 illustrates a flow chart of a method for transmitting a failure notification in accordance with some embodiments of the present application. The method may be performed by a relay UE (e.g., the relay UE 103 illustrated and shown in FIG. 1). Although described with respect to a UE, it should be understood that other devices may be configured to perform a method similar to that of FIG. 5.

In the exemplary method 500 as shown in FIG. 5, a PC5 RRC connection of a link between a UE (e.g., UE 101a illustrated and shown in FIG. 1) and a relay UE (e.g., the relay UE 103 illustrated and shown in FIG. 1) has been established, and a PC5 RRC connection of the link between the relay UE and another UE (e.g., UE 101b illustrated and shown in FIG. 1) has been established. In operation 501, the relay UE detects whether a failure occurs on a link between the relay UE and the abovementioned another UE. In operation 502, if the relay UE detects that a failure occurs on the link between the relay UE and the abovementioned another UE, the relay UE transmits a failure notification to the UE, to indicate an occurrence of the failure on the link between the relay UE and the abovementioned another UE.

In an example, the failure is a sidelink RLF of the link between the relay UE and the abovementioned another UE. In a further example, the failure is a failure during a RRC reconfiguration procedure between the relay UE and the abovementioned another UE, and the failure notification is “a RRC reconfiguration failure for relayed sidelink message”.

The failure notification in the embodiments of FIG. 5 may be of similar formats or contents to those of the failure notification in embodiments of FIG. 4. For instance, similar to the embodiments of FIG. 4, in the embodiments of FIG. 5, the failure notification includes a failure cause, e.g., a sidelink RLF or a configuration failure.

According to some embodiments, the failure notification in the embodiments of FIG. 5 includes the abovementioned another UE's ID, which may also be named as a destination ID. For instance, with reference to FIG. 1, the failure notification includes: a destination ID associated with the link between relay UE 103 and UE 101b; or a destination ID associated with an end-to-end link between UE 101a and UE 101b, if the end-to-end link is established.

Details described in all other embodiments of the present application (for example, details of how to handle a failure on a link between a relay UE and a UE) are applicable for the embodiments of FIG. 5. Moreover, details described in the embodiments of FIG. 5 are applicable for all the embodiments of FIGS. 1-4 and 6-8.

The following texts describe specific Embodiments 1 and 2 of the methods as shown and illustrated in FIGS. 4 and 5.

### Embodiment 1

According to Embodiment 1, a UE (e.g., UE 101a as shown and illustrated in FIG. 1), a relay UE (e.g., the relay UE 103 illustrated and shown in FIG. 1), and another UE (e.g., UE 101b as shown and illustrated in FIG. 1) perform the following steps:
(1) A PC5 RRC connection of PC5 link 1 between UE 101a and the relay UE 103 has been established. Another PC5 RRC connection of PC5 link 2 between the relay UE 103 and UE 101b has been established.
(2) Optionally, a RRC relayed connection between UE 101a and UE 101b is established. The expression “optionally” here means that this step is optional and may not be performed in some embodiments.
   UE 101a transmits “a RRC reconfiguration for relayed sidelink message” to UE 101b, and the message is relayed by the relay UE 103. “A RRC reconfiguration for relayed sidelink message” may also be named as “a RRC reconfiguration for sidelink relayed message,” “a RRC reconfiguration for sidelink relayed connection message,” “a RRC reconfiguration for relayed sidelink connection message,” or the like.
   UE 101b transmits “a RRC reconfiguration complete for relayed sidelink message” to UE 101a, and the message is relayed by the relay UE 103. “A RRC reconfiguration complete for relayed sidelink message” may also be named as “a RRC reconfiguration complete for sidelink relayed message” or the like.
(3) There may be following possible steps of the relay UE 103:
   Step (3a): The relay UE 103 declares a sidelink RLF for the link between the relay UE 103 and UE 101b when the following condition happens:
      [symbol] A trigger condition for transmitting a failure notification with a failure cause of “a sidelink RLF”:
         a) upon an indication from a sidelink RLC entity of the relay UE 103 that the maximum number of retransmissions for a specific destination (i.e., UE 101b) has been reached; or
         b) upon an expiry of timer T400; or
         c) upon an indication from a sidelink MAC entity of the relay UE 103 that the maximum number of consecutive HARQ DTX for a specific destination has been reached; or
         d) upon an integrity check failure indication from a sidelink PDCP entity of the relay UE 103.
   Step (3b): The relay UE 103 receives a RRCReconfigurationFailureSidelink message, after the relay UE 103 transmits a RRCReconfigurationSidelink message to UE 101b.
      [symbol] Trigger condition for transmitting a failure notification with a failure cause of “a configuration failure”:
         a) upon a reception of a RRCReconfigurationFailureSidelink message from UE 101b.
(4) The relay UE 103 transmits a failure notification to UE 101a, when the relay UE 103 declares a sidelink RLF or when the relay UE 103 detects a configuration failure.
   The relay UE 103 reports the failure notification to UE 101a when a RLF of the link between relay UE 103 and UE 101b happens or the relay UE 103 receives a RRCreconfigurationfailure message from UE 101b.
   the following information should be added to the failure notification:
      [symbol] a destination ID association with the link between UE 101a and UE 101b; or a destination ID associated with the link between relay UE 103 and UE 101b.
      [symbol] Failure cause: a sidelink RLF; or a configuration failure.
      [symbol] Optionally, the following further information could be added to the failure notification: a RLC maximum number of retransmissions; T400 expiry; a maximum number of consecutive HARQ DTX; or an integrity check failure.
      The expression “optionally” here means that these further information is optional and may not be included in some embodiments.
(5) UE 101a receives the failure notification from the relay UE 103. The failure information may indicate “a sidelink RLF” or “a configuration failure”.
   If the received failure notification indicates a sidelink RLF between relay UE 103 and UE 101b, UE 101a may perform the following operations:
      [symbol] UE 101a declares a sidelink RLF of the link between UE 101a and UE 101b;
      [symbol] UE 101a declares a sidelink RLF of the link between UE 101a and the relay UE 103;
      [symbol] UE 101a releases DRBs and SRBs of the link between UE 101a and UE 101b;
      [symbol] UE 101a releases DRBs and SRBs of the link between UE 101a and the relay UE 103;
      [symbol] UE 101a discards configuration information of NR sidelink communication of the link between UE 101a and UE 101b;
      [symbol] UE 101a discards configuration information of NR sidelink communication of the link between UE 101a and the relay UE 103;
      [symbol] UE 101a resets the sidelink specific MAC of the link between UE 101a and UE 101b;
      [symbol] UE 101a resets the sidelink specific MAC of the link between UE 101a and the relay UE 103;
      [symbol] UE 101a considers that the PC5 RRC connection of the link between UE 101a and UE 101b has been released;
      [symbol] UE 101a considers that the PC5 RRC connection of the link between UE 101a and relay UE 103 has been released;
      [symbol] UE 101a indicates the release status of the PC5 RRC connection (i.e., the PC5 RRC connection is unavailable) to the upper layers for UE 101b.
(6) When UE 101a receives the failure notification from the relay UE 103, UE 101a may trigger to transmit a SidelinkUEinformation message to the serving BS of UE 101a (e.g., BS 102 as shown and illustrated in FIG. 1). Meanwhile, UE 101a is triggered to monitor a discovery resource pool for a relay reselection procedure.
   Regarding whether UE 101a reports the failure information of the end-to-end relayed connection to the BS:
      [symbol] UE 101a receives the failure information from the relay UE 103. The failure information includes a destination ID of UE 101b, a failure cause, an ID of the relay UE 103.
      [symbol] New failure cause for this case may be: the reception of a sidelink RLF or the reception of a configuration failure.
      [symbol] The failure information includes a real destination ID associated with multiple hops, e.g., an ID of UE 101b.
      [symbol] After the BS receives the failure information, the BS may reconfigure the UE 101a to perform a relay reselection procedure.

### Embodiment 2

Similar to Embodiment 1, according to Embodiment 2, a UE (e.g., UE 101a as shown and illustrated in FIG. 1), a relay UE (e.g., the relay UE 103 illustrated and shown in FIG. 1), and another UE (e.g., UE 101b as shown and illustrated in FIG. 1) perform the following steps. Steps (1) and (2) of Embodiment 2 are the same as steps (1) and (2) of Embodiment 1.
(1) A PC5 RRC connection of PC5 link 1 between UE 101a and the relay UE 103 has been established. Another PC5 RRC connection of PC5 link 2 between the relay UE 103 and UE 101b has been established.
(2) Optionally, a RRC relayed connection of a link between UE 101a and UE 101b has been established. The expression “optionally” here means that this step is optional and may not be performed in some embodiments.
(3) UE 101a declares a sidelink RLF of the link between UE 101a and the relay UE 103. Or, UE 101a receives a RRCReconfigurationFailureSidelink message from the relay UE 103, after UE 101a transmits a RRCReconfigurationSidelink message to the relay UE 103.
(4) UE 101a is triggered to monitor a discovery resource pool for a relay reselection procedure.

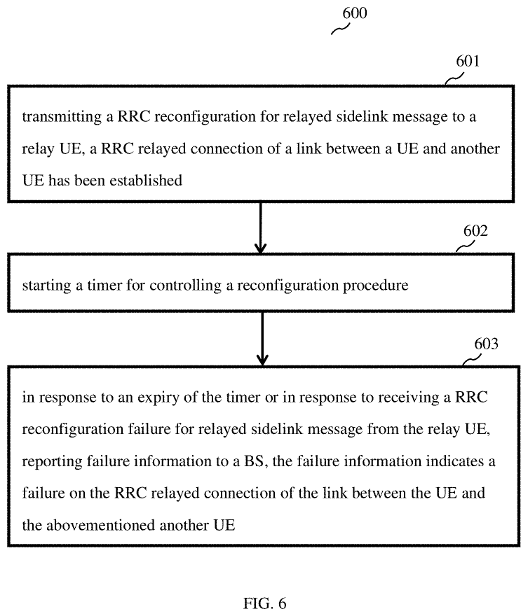

FIG. 6 illustrates a flow chart of a method for reporting failure information in accordance with some embodiments of the present application. The method may be performed by a UE (e.g., UE 101a or UE 101b as illustrated and shown in FIG. 1, UE (a) as illustrated and shown in FIG. 2, or the UE as illustrated and shown in FIG. 3). Although described with respect to a UE, it should be understood that other devices may be configured to perform a method similar to that of FIG. 6.

In the exemplary method 600 as shown in FIG. 6, a RRC relayed connection of a link between a UE (e.g., UE 101a illustrated and shown in FIG. 1) and another UE (e.g., UE 101b illustrated and shown in FIG. 1) has been established. In operation 601, the UE transmits “a RRC reconfiguration for relayed sidelink message” to a relay UE (e.g., the relay UE 103 illustrated and shown in FIG. 1).

In operation 602, the UE starts a timer for controlling a reconfiguration procedure. In operation 603, if the timer expiries or the UE receives a RRC reconfiguration failure for relayed sidelink message from the relay UE, the UE reports failure information to a BS (e.g., the BS 102 illustrated and shown in FIG. 1). The failure information indicates a failure on the RRC relayed connection of the link between the UE and the abovementioned another UE.

The failure information in the embodiments of FIG. 6 is of similar formats or contents to those of the failure information in embodiments of FIG. 4. For instance, similar to the embodiments of FIG. 4, in the embodiments of FIG. 6, the failure information may include: a status of the link between the UE and the relay UE; and a status of the link between the relay UE and the abovementioned another UE. Each of the statuses may represent “an occurrence of a RLF” or “a link being available”.

According to some embodiments, the UE receives a RRC reconfiguration message from the BS and performs the relay reselection procedure. The RRC reconfiguration message instructs the UE to perform a relay re-selection procedure. According to some other embodiments, the UE autonomously performs a relay reselection procedure. For example, the UE autonomously performs a relay reselection procedure upon reporting the failure information to the B S. The relay reselection procedure in the embodiments of FIG. 6 is similar to that in the embodiments of FIG. 4.

In an example, the failure information includes the abovementioned another UE's ID, which may also be named as a destination ID. For instance, with reference to FIG. 1, the failure information includes:
a destination ID associated with an end-to-end link between UE 101a and UE 101b, if the end-to-end link is established; or
a destination ID associated with the link between relay UE 103 and UE 101b.

In an example, the failure information includes a failure cause. For instance, the failure cause may be a sidelink RLF of the RRC relayed connection of the link between UE 101a and UE 101b. The failure cause may be a configuration failure of the RRC relayed connection of the link between UE 101a and UE 101b.

In an embodiment, the UE declares a sidelink RLF of the link between the UE and the abovementioned another UE. For instance, UE 101a declares a sidelink RLF of the link between UE 101a and UE 101b.

In a further embodiment, the UE further performs the following operations:
releasing DRBs and SRBs of the link between the UE and the abovementioned another UE;
discarding sidelink communication configuration information of the link between the UE and the abovementioned another UE;
resetting sidelink specific MAC configuration information of the link between the UE and the abovementioned another UE;
setting “a connection status” of the link between the UE and the abovementioned another UE to “a release status”; and
indicating “the release status of the link between the UE and the abovementioned another UE” to the upper layer of the abovementioned another UE.

Details described in all other embodiments of the present application (for example, details of how to handle a failure on a link between a relay UE and a UE) are applicable for the embodiments of FIG. 6. Moreover, details described in the embodiments of FIG. 6 are applicable for all the embodiments of FIGS. 1-5, 7, and 8.

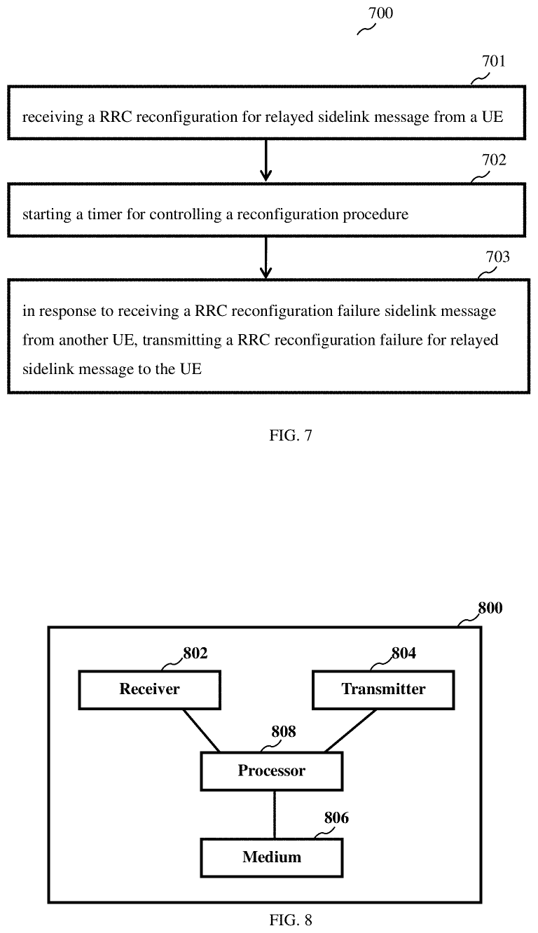

FIG. 7 illustrates a flow chart of a method for transmitting a RRC reconfiguration failure for relayed sidelink message in accordance with some embodiments of the present application. The method may be performed by a relay UE (e.g., the relay UE 103 illustrated and shown in FIG. 1). Although described with respect to a UE, it should be understood that other devices may be configured to perform a method similar to that of FIG. 7.

In the exemplary method 700 as shown in FIG. 7, in operation 701, a relay UE (e.g., the relay UE 103 illustrated and shown in FIG. 1) receives “a RRC reconfiguration for relayed sidelink message” from a UE (e.g., UE 101a illustrated and shown in FIG. 1). In operation 702, the relay UE starts a timer for controlling a reconfiguration procedure. In operation 703, if the relay UE receives a RRC reconfiguration failure sidelink message from another UE (e.g., UE 101b illustrated and shown in FIG. 1), the relay UE transmits “a RRC reconfiguration failure for relayed sidelink message” to the UE.

In an embodiment, the relay UE further transmits “the RRC reconfiguration for relayed sidelink message” to the abovementioned another UE. For instance, “the RRC reconfiguration failure for relayed sidelink message” includes the abovementioned another UE's ID, which may also be named as a destination ID. With reference to FIG. 1, “the RRC reconfiguration failure for relayed sidelink message” may include: a destination ID associated with the link between relay UE 103 and UE 101b; or a destination ID associated with an end-to-end link between UE 101a and UE 101b, if the end-to-end link is established.

In an example, “the RRC reconfiguration failure for relayed sidelink message” includes a failure cause. Similar to the failure cause in the failure notification of the embodiments of FIGS. 4-6, the failure cause in “the RRC reconfiguration failure for relayed sidelink message” includes a sidelink RLF or a configuration failure.

Details described in all other embodiments of the present application (for example, details of how to handle a failure on a link between a relay UE and a UE) are applicable for the embodiments of FIG. 7. Moreover, details described in the embodiments of FIG. 7 are applicable for all the embodiments of FIGS. 1-6 and 8.

The following texts describe specific Embodiment 3 of the methods as shown and illustrated in FIGS. 6 and 7.

### Embodiment 3

According to Embodiment 3, a UE (e.g., UE 101a as shown and illustrated in FIG. 1), a relay UE (e.g., the relay UE 103 illustrated and shown in FIG. 1), and another UE (e.g., UE 101b as shown and illustrated in FIG. 1) perform the following steps:
(1) A PC5 RRC connection of PC5 link 1 between UE 101a and the relay UE 103 has been established. Another PC5 RRC connection of PC5 link 2 between the relay UE 103 and UE 101b has been established.
(2) Optionally, UE 101a transmits “a RRC reconfiguration for relayed sidelink message” to UE 101b via by relay UE 103. The expression “optionally” here means that this step is optional and may not be performed in some embodiments.
   a) In case 1-1:
      i. UE 101a starts a timer when UE 101A transmits “a RRC Reconfiguration for relayed sidelink message”. The timer is used to control the RRC reconfiguration procedure.
      ii. UE 101a reports failure information to a network or a BS (e.g., the BS 102 illustrated and shown in FIG. 1) upon an expiry of this timer.
   b) In case 1-2:
      i. After UE 101a transmits “a RRC reconfiguration for relayed sidelink message” to UE 101b, UE 101a receives “a RRC reconfiguration failure for relayed sidelink message”.
(3) UE 101a may receive “a RRC reconfiguration failure for relayed sidelink message” from UE 101b, and the message is relayed by relay UE. Otherwise, the timer for controlling a RRC reconfiguration procedure may expire.
(4) UE 101a reports failure information to the BS.
   a) The failure information may be included in a SidelinkUEInformation message.
   b) The failure information includes a destination ID (e.g., an ID of UE 101b), a failure cause, an ID of the relay UE 103.
      i. New failure cause for case 1-1: the sidelink RLF of the relayed connection.
      ii. New failure case for case 1-2: configuration failure of the relayed connection.
   c) The status of the link between UE 101a and the relay UE 103 could also be included in the failure information, which may be helpful for the BS's decision.
   d) The status of the link between the relay UE 103 and UE 101b could be included in the failure information.
      i. UE 101a may report the failure information to the relay UE 103. The relay UE 103 may response to UE 101a whether the link between relay UE 103 and UE 101b is available or not.
   e) The failure information includes a real destination associated with multiple hops, e.g., an ID of UE101b.
   f) After the BS receives the failure information from UE101a, the BS may reconfigure the UE to perform a relay reselection procedure.

FIG. 8 illustrates a simplified block diagram of an apparatus for a failure handling procedure in accordance with some embodiments of the present application.

In some embodiments of the present application, the apparatus 800 may be a UE (e.g., UE 101a or UE 101b as illustrated and shown in FIG. 1, UE (a) as illustrated and shown in FIG. 2, or the UE as illustrated and shown in FIG. 3), which can at least perform the method illustrated in FIG. 4 or FIG. 6.

In some other embodiments of the present application, the apparatus 800 may be a relay UE (e.g., the relay UE 103 as illustrated and shown in FIG. 1 or UE (b) as illustrated and shown in FIG. 2), which can at least perform the method illustrated in FIG. 5 or FIG. 7.

In some additional embodiments of the present application, the apparatus 800 may be a BS (e.g., the BS 102 as illustrated and shown in FIG. 1 or the BS as illustrated and shown in FIG. 3), which can at least perform some method steps as illustrated in any one of FIGS. 4-7.

As shown in FIG. 8, the apparatus 800 may include at least one receiver 802, at least one transmitter 804, at least one non-transitory computer-readable medium 806, and at least one processor 808 coupled to the at least one receiver 802, the at least one transmitter 804, and the at least one non-transitory computer-readable medium 806.

Although in FIG. 8, elements such as the at least one receiver 802, the at least one transmitter 804, the at least one non-transitory computer-readable medium 806, and the at least one processor 808 are described in the singular, the plural is contemplated unless limitation to the singular is explicitly stated. In some embodiments of the present application, the at least one receiver 802 and the at least one transmitter 804 are combined into a single device, such as a transceiver. In certain embodiments of the present application, the apparatus 800 may further include an input device, a memory, and/or other components.

In some embodiments of the present application, the at least one non-transitory computer-readable medium 806 may have stored thereon computer-executable instructions which are programmed to implement the operations of the methods, for example as described in view of any one of FIGS. 4-7, with the at least one receiver 802, the at least one transmitter 804, and the at least one processor 808.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1.-16. (canceled)

17-22. (canceled)

23-33. (canceled)

34-37. (canceled)

38. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to:
establish a first PC5 radio resource control (RRC) connection of a link between the apparatus and a relay user equipment (UE), the apparatus being a first UE, wherein a second PC5 RRC connection of a link between the relay UE and a second UE has been established; and
receive a failure notification from the relay UE, wherein the failure notification indicates an occurrence of a failure on the link between the relay UE and the second UE.

39.-41. (canceled)

42. The apparatus of claim 38, wherein the computer-executable instructions cause the at least one processor to:
establish a RRC relayed connection of a link between the apparatus and the second UE.

43. The apparatus of claim 38, wherein the failure notification includes one of:
an identifier (ID) of the second UE associated with a RRC relayed connection of a link between the apparatus and the second UE, in response to the RRC relayed connection of the link between the apparatus and the second UE being established; and
an ID of the second UE associated with the link between the relay UE and the second UE.

44. The apparatus of claim 38, wherein the failure notification includes a failure cause, and wherein the failure cause includes one of:
a sidelink radio link failure (RLF); and
a configuration failure.

45. The apparatus of claim 44, wherein the failure notification further includes at least one failure cause from among:
reaching a maximum number of retransmissions of a RLC entity of the relay UE;
an expiry of a timer for transmission of RRC reconfiguration for sidelink;
reaching a maximum number of consecutive hybrid automatic repeat request (HARQ) discontinuous transmission (DTX); and
an integrity check failure.

46. The apparatus of claim 38, wherein the computer-executable instructions cause the at least one processor to perform one of:
declare a sidelink RLF of the link between the first UE and the relay UE; or
in response to a RRC relayed connection of a link between the first UE and the second UE being established, declare a sidelink RLF of the link between the first UE and the second UE.

47. The apparatus of claim 38, further comprising: wherein the computer-executable instructions cause the at least one processor to:
release data radio bearers (DRBs) and signaling radio bearers (SRBs) of the link between the apparatus and the relay UE;
discard sidelink communication configuration information of the link between the apparatus and the relay UE; and
in response to a RRC relayed connection of a link between the apparatus and the second UE being established:
release DRBs and SRBs of the link between the apparatus and the second UE; and
discard sidelink communication configuration information of the link between the apparatus and the second UE.

48. The apparatus of claim 38, wherein the computer-executable instructions cause the at least one processor to:
reset sidelink specific medium access control (MAC) configuration information of the link between the apparatus and the relay UE;
set a connection status of the link between the apparatus and the relay UE to a release status;
indicate the release status of the link between the apparatus and the relay UE to an upper layer of the second UE; and
in response to a RRC relayed connection of a link between the apparatus and the second UE being established:
reset sidelink specific MAC configuration information of the link between the apparatus and the second UE;
set a connection status of the link between the apparatus and the second UE to a release status; and
indicate the release status of the link between the apparatus and the second UE to the upper layer of the second UE.

49. The apparatus of claim 38, wherein the failure notification is included in one of:
a RRC signaling;
a control packet data unit (PDU) in a sidelink adaptation protocol (SLAP) layer; and
a MAC control element (CE).

50. The apparatus of claim 38, wherein the computer-executable instructions cause the at least one processor to:
determine whether the apparatus is in coverage of a base station (BS); and
in response to determining that the apparatus being in the coverage of the BS, report failure information to the BS upon receiving the failure notification, wherein the failure information is associated with the failure notification.

51. The apparatus of claim 50, wherein the failure information includes:
a status of the link between the apparatus and the relay UE; and
a status of the link between the relay UE and the second UE;
wherein the status of the link between the apparatus and the relay UE or the status of the link between the relay UE and the second UE represents one of:
an occurrence of a RLF; and
a link being available.

52. The apparatus of claim 38, wherein the computer-executable instructions cause the at least one processor to:
receive a RRC reconfiguration message from a BS, wherein the RRC reconfiguration message instructs the first UE to perform a relay reselection procedure; and
performing the relay reselection procedure.

53. The apparatus of claim 38, wherein the computer-executable instructions cause the at least one processor to:
perform a relay reselection procedure in response to receiving the failure notification.

54. The apparatus of claim 53, wherein performing the relay reselection procedure further comprises:
monitor a discovery resource pool to find one or more relay UEs;
select one relay UE within the one or more relay UEs; and
establish a PC5 RRC connection of a link between the apparatus and the selected one relay UE.

55. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to:
detect whether a failure occurs on a link between the apparatus and a second user equipment (UE), the apparatus being a relay UE, wherein a first PC5 radio resource control (RRC) connection of a link between a first UE and the apparatus has been established, and wherein a second PC5 RRC connection of the link between the apparatus and the second UE has been established; and
in response to detecting that the failure occurs on the link between the apparatus and the second UE, transmit a failure notification to the apparatus, wherein the failure notification indicates an occurrence of the failure on the link between the apparatus and the second UE.

56. The apparatus of claim 55, wherein the failure on the link between the apparatus and the second UE is one of:
a sidelink radio link failure (RLF) of the link between the apparatus and the second UE; and
a failure during a RRC reconfiguration procedure between the apparatus and the second UE, wherein the failure notification is a RRC reconfiguration failure for relayed sidelink message.

57. The apparatus of claim 55, wherein the failure notification includes a failure cause, and wherein the failure cause includes one of:
a sidelink RLF; and
a configuration failure.

58. The apparatus of claim 57, wherein the failure notification further includes at least one failure cause of:
reaching a maximum number of retransmissions of a radio link control (RLC) entity of the apparatus;
an expiry of a timer for transmission of RRC reconfiguration for sidelink;
reaching a maximum number of consecutive hybrid automatic repeat request (HARQ) discontinuous transmission (DTX); and
an integrity check failure.

59. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to:
transmit a radio resource control (RRC) reconfiguration for relayed sidelink message to a relay UE, wherein a RRC relayed connection of a link between the apparatus and a second user equipment (UE) has been established, the apparatus being a first UE;
start a timer for controlling a reconfiguration procedure; and
in response to an expiry of the timer or in response to receiving a RRC reconfiguration failure for relayed sidelink message from the relay UE, report failure information to a base station (BS), wherein the failure information indicates a failure on the RRC relayed connection of the link between the apparatus and the second UE.

60. The apparatus of any of claim 57, wherein to perform the relay reselection procedure, the processor:
monitors a discovery resource pool to find one or more relay UEs;
selects one relay UE within the one or more relay UEs; and
establishes a PC5 RRC connection of a link between the first UE and the one selected relay UE.
